(19) United States
(12) Patent Application Publication
(10) Pub. No.: US 2008/0005590 A1
(43) Pub. Date: Jan. 3, 2008

(54) Memory system

(75) Inventors: Akihiro Kasahara, Sambu-gun (JP); Hiroshi Suu, Chigasaki-shi (JP); Akira Miura, Sagamihara-shi (JP); Shinji Saito, Yokohama-shi (JP); Hiroyuki Sakamoto, Yokohama-shi (JP)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: KABUSHIKI KAISHA TOSHIBA

(21) Appl. No.: 11/810,234

(22) Filed: Jun. 5, 2007

(30) Foreign Application Priority Data
Jun. 8, 2006 (JP) 2006-160064

(51) Int. Cl. G06F 12/14

(52) U.S. Cl. 713/193

(57) ABSTRACT

A memory system receives data from a host device which requests data write, supplies data to a host device which requests data read, and includes a nonvolatile semiconductor memory and a controller. The memory stores supplied data, and outputs data stored in a designated address. The controller supplies the memory with data in an encrypted form in accordance with a DRM technique employed by a host device which requests data write, and outputs data in an encrypted form in accordance with a DRM technique employed by a host device which requests data read.

### CROSS-REFERENCE TO RELATED APPLICATIONS

This application is based upon and claims the benefit of priority from prior Japanese Patent Application No. 2006-160064, filed Jun. 8, 2006, the entire contents of which are incorporated herein by reference.

### BACKGROUND OF THE INVENTION

1. Field of the Invention

The present invention relates to a memory system, and more particularly to a memory system that includes, for example, a nonvolatile semiconductor memory and a controller for controlling the operation of the memory, and is inserted in a host device.

2. Description of the Related Art

Memory cards using nonvolatile memories, such as flash memories, are used as a recording medium for storing content such as music data and video data. NAND flash memories are typical flash memories used as memory cards. A memory card is inserted in a host device, such as a music player or digital camera, and used to store data from the host device and/or supply data stored therein to the host device.

Since the content stored in memory cards is digital data, its quality is not degraded even after it is copied many times. In recent years, distribution and exchange of illegal copies of such non-degraded quality data have been more and more increased. In view of this, there is a demand for protecting the copyright of content.

As a method for protecting the copyright of the content stored in memory cards, a technique generally called digital rights management (DRM) is known. DRM is a technology for limiting distribution and reproduction of content. DRM includes various techniques. A DRM utilizing encryption is one of the techniques.

A DRM example utilizing encryption will now be described. The content, which is provided from a content provider to users via a communication medium, such as the Internet, and stored in their memory cards, is encrypted. When encrypting content, a content key produced using information unique to each memory card is used. This content key is also provided by the content provider and stored in each memory card via a host device.

When a host device replays the content stored in a memory card inserted therein, it receives, from the memory card, the content, content key and information unique to the memory card. Using the content key and information unique to the memory card, the host device decrypts the content. The content key appropriately functions only when it is used along with the information unique to the memory card used to produce the key. Accordingly, even if the content or content key is illegally copied to a memory card, the copied content or key cannot be decoded since the information unique to the memory card differs from that unique to the legal memory card. In contrast, if content in a memory card is a legitimately stored one, and decoding is performed under legal conditions (e.g., if the use of the content satisfies permitted conditions), the content can be successfully decoded. Namely, the host device can replay the content.

Some different schemes including different content encryption schemes are available as DRM schemes using encryption. Content encrypted by a certain encryption scheme cannot be replayed by a host device using another encryption scheme, even if the content in the memory card is legally acquired. This degrades convenience for users.

JP-A No. 2005-316992 (KOKAI) discloses, in FIG. 2 and the description related to FIG. 2, an IC card 50 managed so that two card applications 61 and 62 can access only their corresponding areas included in a secure flash memory area 56.

### BRIEF SUMMARY OF THE INVENTION

According to an aspect of the present invention, there is provided a memory system receiving data from a host device which requests data write, and supplying data to a host device which requests data read, comprising: a nonvolatile semiconductor memory storing supplied data, and outputting data stored in a designated address; and a controller supplying the memory with data in an encrypted form in accordance with a DRM technique employed by a host device which requests data write, and outputting data in an encrypted form in accordance with a DRM technique employed by a host device which requests data read.

### BRIEF DESCRIPTION OF THE SEVERAL VIEWS OF THE DRAWING

FIG. 1 shows a block diagram of common functional blocks for memory systems according to embodiments;

FIG. 2 shows a block diagram of a memory system according to a first embodiment;

FIG. 3 shows a block diagram of another memory system according to the first embodiment;

FIG. 4 shows a sequence of write operation performed in the memory system of the first embodiment;

FIG. 5 shows a flow of the write operation of the memory system of the first embodiment;

FIG. 6 shows data states in the write operation of the memory system of the first embodiment;

FIG. 7 shows a sequence of read operations performed in the memory system of the first embodiment;

FIG. 8 shows a flow of the read operation of the memory system of the first embodiment;

FIG. 9 shows data states in the read operation of the memory system of the first embodiment;

FIG. 10 shows data states in the read operation of the memory system of the first embodiment;

FIG. 11 shows a sequence of write operations performed in a memory system according to a second embodiment;

FIG. 12 shows a flow of the write operation of the memory system of the second embodiment;

FIG. 13 shows data states in the write operation of the memory system of the second embodiment;

FIG. 14 shows a block diagram of a memory system according to a third embodiment;

FIG. 15 shows a block diagram of another memory system according to the third embodiment;

FIG. 16 shows a sequence of write operations performed in each memory system of the third embodiment;

FIG. 17 shows a flow of the write operation of each memory system of the third embodiment;

FIG. 18 shows data states in the write operation of each memory system of the third embodiment;

FIG. 19 shows a sequence of read operations performed in the memory system of the third embodiment;

FIG. 20 shows a flow of the read operation of each memory system of the third embodiment;

FIG. 21 shows data states in the read operation of each memory system of the third embodiment;

FIG. 22 shows data states in the write operation of a memory system according to a modified third embodiment;

FIG. 23 shows data states in the read operation of the memory system according to the modified third embodiment;

FIG. 24 shows a sequence of write operations performed in a memory system according to a fourth embodiment;

FIG. 25 shows a flow of the write operation of the memory system of the fourth embodiment;

FIG. 26 shows data states in the write operation of the memory system of the fourth embodiment;

FIG. 27 shows a sequence of read operations performed in the memory system of the fourth embodiment;

FIG. 28 shows a flow of the read operation of the memory system of the fourth embodiment; and

FIG. 29 shows data states in the read operation of the memory system of the fourth embodiment.

### DETAILED DESCRIPTION OF THE INVENTION

Embodiments of the invention will be described with reference to the accompanying drawings. In the embodiments, like reference numbers denote like elements, and duplication of description will be made only when necessary.

### Common Structure between the Embodiments

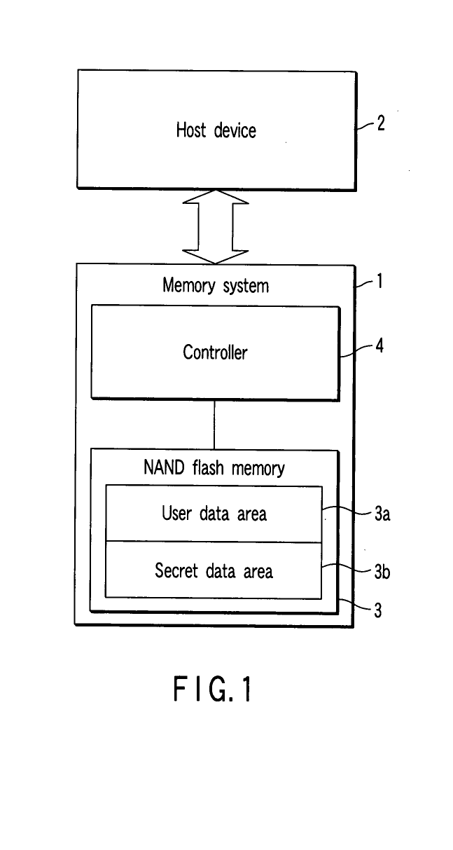

FIG. 1 is a block diagram illustrating common functional blocks between memory systems according to the embodiments.

Each of the functional blocks of FIG. 1 can be realized by hardware, software or their combination. Accordingly, each block will be described mainly in view of its function, to clarity which one of them provides it. Whether each function is realized by hardware, software or their combination depends upon design constraints on a specific embodiment or the entire system. A person skilled in the art can realize the functions by various methods, and determination as to how to realize them is included in the scope of the invention.

As shown in FIG. 1, a memory system 1 comprises a NAND flash memory (hereinafter referred to simply as “the flash memory”) 3 and controller 4. The memory system 1 is inserted in a host device 2 to perform transfer of data with the host device 2. The memory system is, for example, a memory card or SD™ card.

The host device 2 can be any device which can supply the memory system 1 with data produced by the software on the device, and can receive data from the memory system 1 and replay or edit the data. The host device can be, for example, a personal computer, music player or digital camera.

The host device 2 is configured to apply a technique (hereinafter referred to as “the DRM technique”) for realizing arbitrary DRM to various types of data to be stored in the memory system 1, and restores DRM-applied data read therefrom. For instance, the host device 2 encrypts data to be supplied to the memory system 1, using the DRM technique. The DRM techniques including encryption include, for example, CRPM, WMT, and Open Magic Gate.

Assume hereinafter that the host device 2 corresponds to an encryption scheme using only one DRM technique.

The flash memory 3 stores or read data in accordance with external command and address signals. Each page of the flash memory 3 has a management data storing section of 2112B (a data area of 512B×4+a redundancy area of 10B×4+a management data area of 24B). Erasure is executed in units of blocks each of which corresponds to 128 pages and has 256 kB+8 kB (k=1024).

The flash memory 3 has a page buffer for input/output of data to/from the flash memory 3. The memory capacity of the page buffer is 2112B (2048B+64B). During, for example, data writing, the page buffer executes data input/output processing to/from the flash memory 3 in units of pages (one page corresponding to the memory capacity of the page buffer).

When the memory capacity of the flash memory 3 is, for example, 1 G bits, the number of 256 kB-blocks (units of erasure) is 512.

The flash memory 3 at least includes a user data area 3a and secret data area 3b as a data storing area. The user data area 3a can be freely accessed and used by the user of the memory system 1, and stores user data.

The secret data area 3b stores a content key used for encryption, secret data or security data used for identification, and/or card information such as a media ID unique to the memory system 1 or system data. The secret data area 3b is a secure area that is accessed by the controller 4 to acquire or store information necessary for operating the memory system 1, and cannot freely be accessed by the user of the memory system 1. Namely, the user cannot read data from the secret data area 3b simply by designating the address thereof. To access it, processing for identification between the host device 2 and memory system 1 is needed. For identification, a secret key, for example, is necessary.

The controller 4 receives, from the host device 2, a data read command, data write command, address of a read/write target, write data, etc. The controller 4 instructs the flash memory 3 to perform reading/writing in accordance with each command.

The controller 4 manages the internal physical state of the flash memory 3 (e.g., in which physical block address target logical sector address data is stored, or which block is erased).

As will be described later, communication between the memory system 1 and host device 2 may be realized via more than one interface in a certain embodiment.

In each of the embodiments described below, write data to be supplied to the memory system 1 is encrypted in the host device 2, using a content key and information unique to the memory system 1, to prevent illegal data copy. However, this is not the only one method. Another method which uses other information along with a content key for encryption may be employed may be employed so long as illegal copy can be prevented.

### First Embodiment

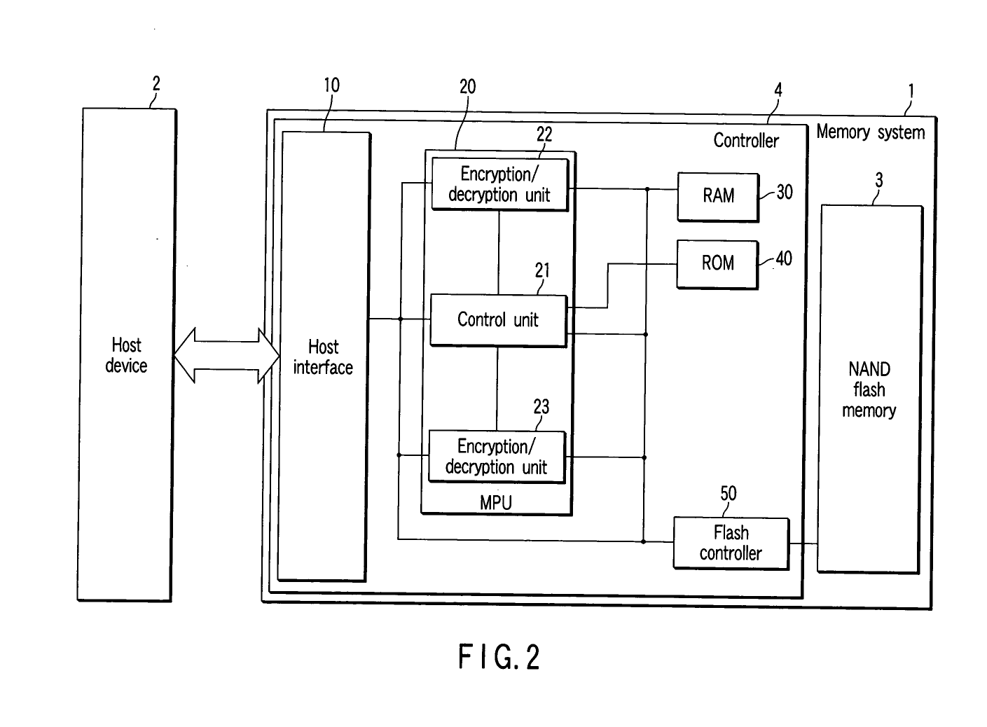

FIG. 2 is a block diagram illustrating the essential part of a memory system according to a first embodiment. As shown in FIG. 2, a controller 4 incorporated in the first embodiment comprises a host interface 10, micro processing unit (MPU) 20, random access memory (RAM) 30, read only memory (ROM) 40 and flash controller 50.

In FIG. 2, the functional blocks which transmit/receive signals are connected by signal lines. However, it is a matter of course that the blocks may be connected to each other via a bus.

The host interface 10 can access the host device 2. This interface may be, for example, USB, SD™ CARD or PC CARD interfaces. The host interface 10 has a configuration according to the DRM technique supported by the controller 4. For instance, when the controller 4 supports two or more DRM techniques that rely on a single interface, e.g., a USB, the host interface 10 is realized as a USB interface.

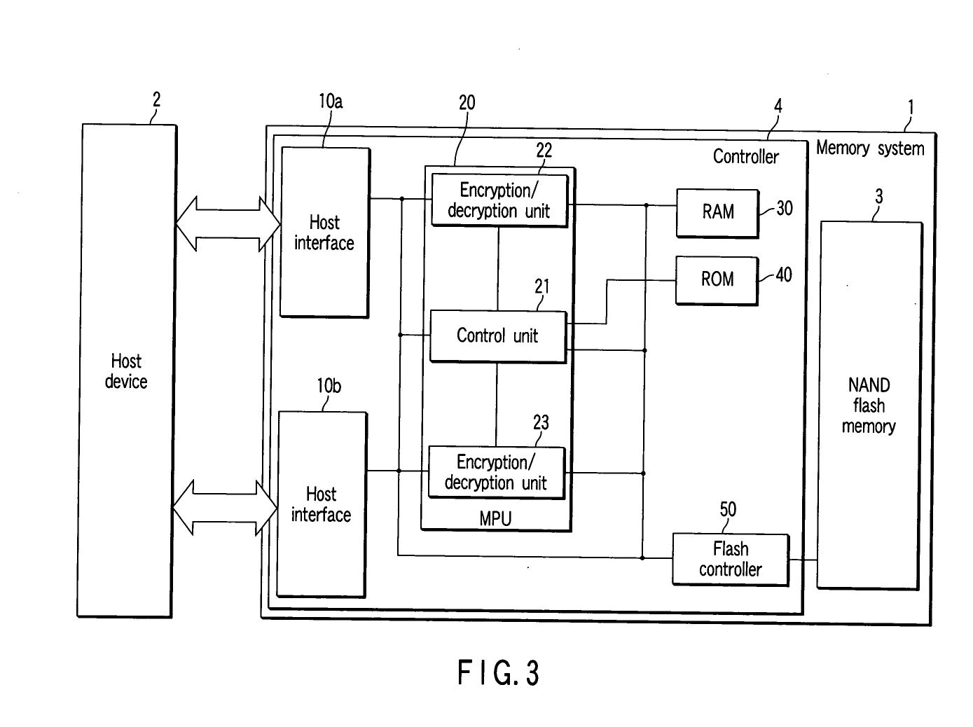

In contrast, when the controller 4 supports two DRM techniques that are designed for communication performed via different interfaces, such as a USB interface and SD™ CARD interface, the host interface 10 includes two interfaces 10a and 10b as shown in FIG. 3. In the case of three or more DRM techniques, the host interface 10 includes three ore more interfaces.

The host interface 10 (10a, 10b) includes, as software, an application program interface (API) that enables communication between the controller 4 and host device 2, and includes, as hardware, a terminal (port) that enables physical interconnection and supply of power.

The MPU 20 comprises a control unit 21 and encryption/decryption units 22 and 23, and controls the controller 4 entirely. When, for example, the memory system 1 is supplied with power, the MPU 20 reads firmware (control program) from the ROM 40, sets it on the RAM 30, and executes preset processing to thereby produce various tables on the RAM 30.

More specifically, upon supply of power, the MPU 20 detects the relationship between the logical addresses assigned to respective data items stored on the pages, and the pages (the physical addresses of the pages in the flash memory 3) on which the data items with the logical addresses are stored, and produces a conversion table for the physical addresses/logical addresses. Further, the MPU 20 supplies the host device 2 with management information indicating the linkage, attributes, etc., of the logical addresses stored in the flash memory 3. When reading data, the MPU 20 converts, into the corresponding physical address, a logical address supplied from the host device 2, and accesses the flash memory 30 via the flash controller 50.

The MPU 20 receives, from the host device 2, a write command, read command or erasure command and executes preset processing on the flash memory 3.

The control unit 21 is the essential part of the MPU 20, and controls the entire MPU 20.

The encryption/decryption units 22 and 23 encrypt plain text data to realize a DRM technique, and decrypt encrypted data. Each of the encryption/decryption units 22 and 23 can be realized by, for example, known encryption/decryption programs, or a chip for realizing the programs.

The encryption/decryption units 22 and 23 encrypt and/or decrypt content data to realize DRM including encryption. The encryption/decryption units 22 and 23 support different DRM techniques. The DRM techniques supported by the encryption/decryption units 22 and 23 are, for example, CPRM, windows media technology (WMT) and Open Magic Gate.

The ROM 40 stores, for example, control programs executed by the MPU 20. The RAM 30 is used as a working memory for the MPU 20, and temporarily stores control programs and various tables. The RAM 30 may be a static random access memory (SRAM).

The flash controller 50 performs interfacing processing between the controller 4 and flash memory 3.

The controller 4 may incorporate a buffer (not shown) that temporarily stores data from the host device 2 or flash memory 3.

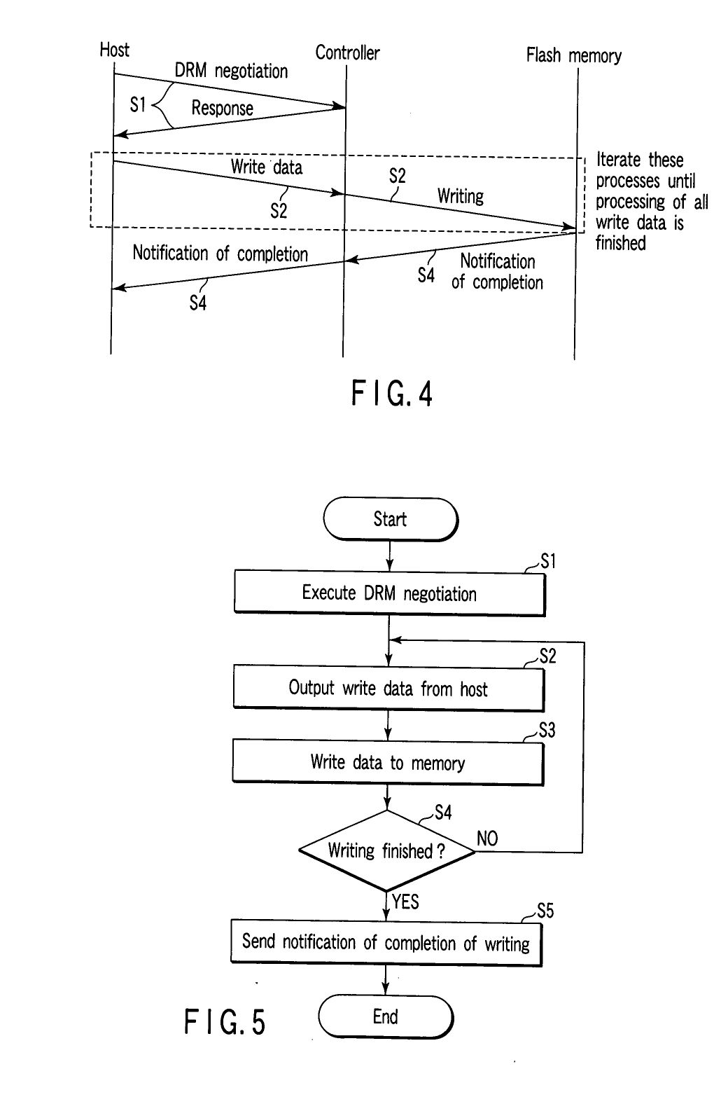

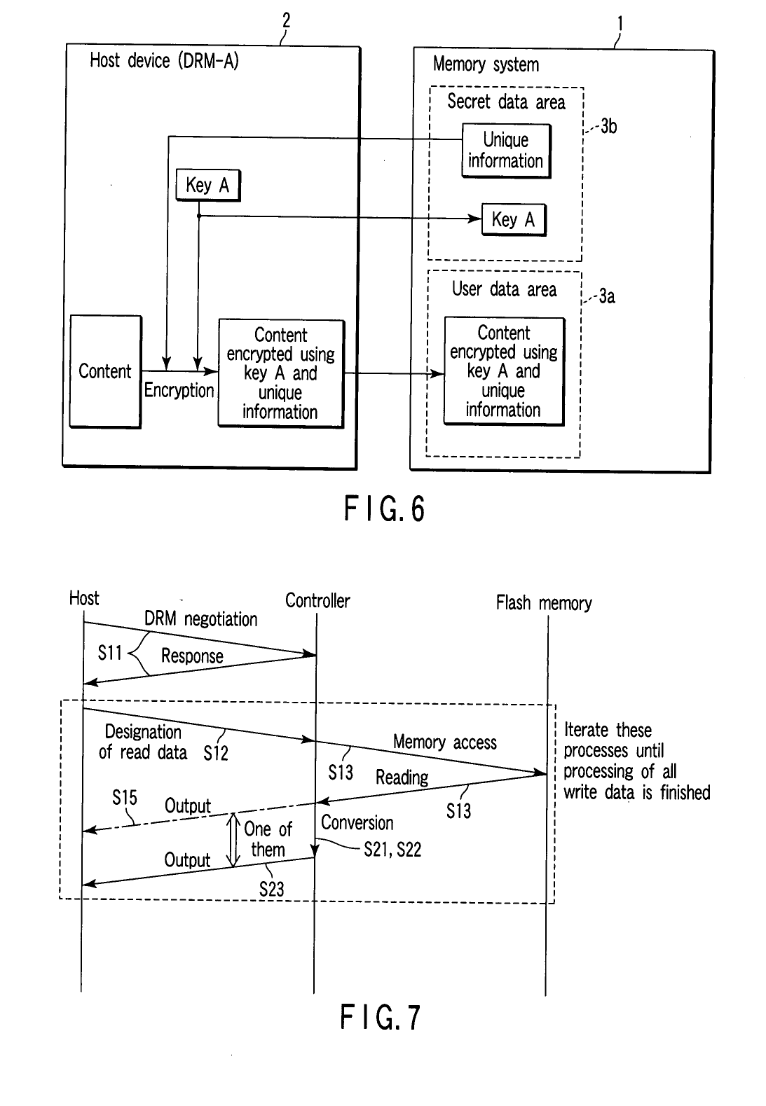

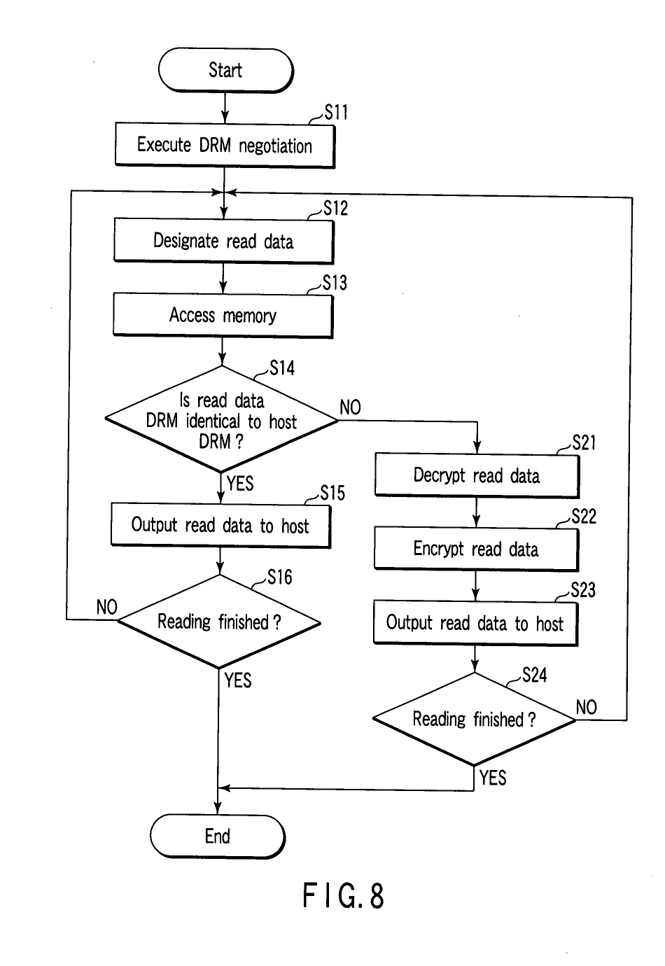

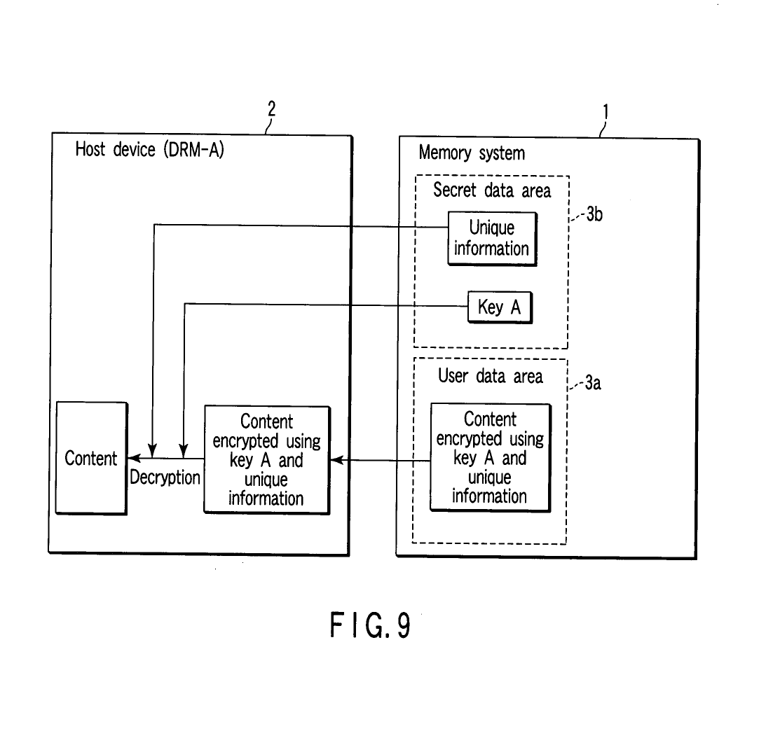

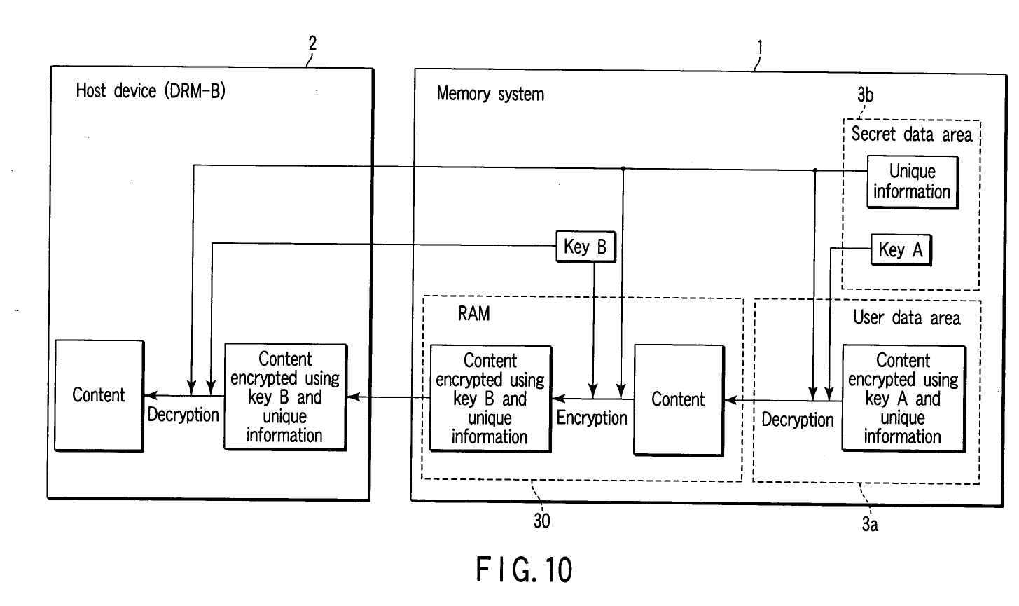

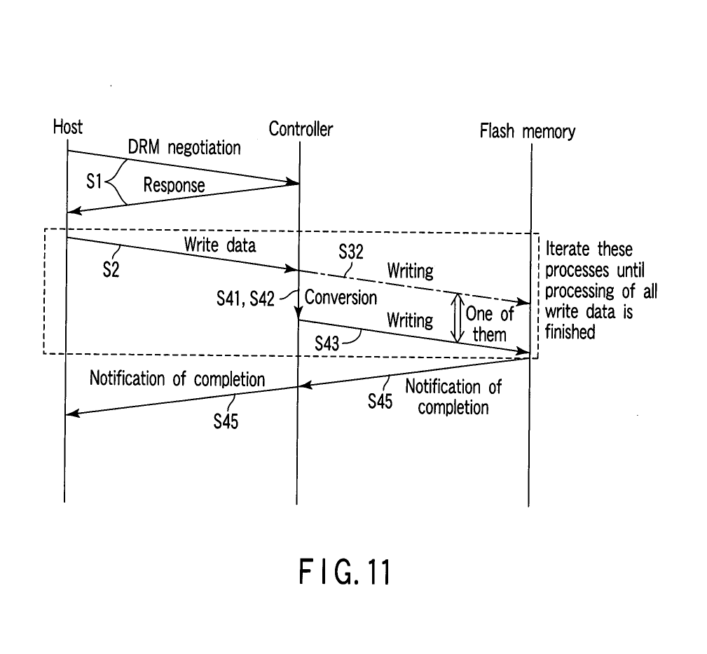

Referring now to FIGS. 4 to 10, a description will be given of the operation of the memory systems shown in FIGS. 2 and 3. FIGS. 4 and 5 show a sequence and a flow of the write operation of the memory system of the first embodiment, respectively. FIG. 6 shows data sent from and received by the memory system of the first embodiment during writing, and write data states. FIGS. 7 and 8 show a sequence and a flow of the read operation of the memory system of the first embodiment, respectively. FIGS. 9 and 10 show data sent and received by the memory system of the first embodiment during reading, and read data states.

Referring first to FIGS. 4 to 6, the operation of writing data to the memory system 1 will be described. When writing data to the memory system 1, the host device 2, which requests to write content data to the system 1, negotiates on DRM with the controller 4 (control unit 21) (step S1).

The negotiation at step S1 includes acquisition, from the memory system 1, information unique to the memory system 1 and necessary for encryption according to the DRM technique (DRM-A) employed in the host device 2. This information may include media ID stored in the secret data area 3b of the flash memory 3. Further, during the negotiation at step S1, the controller 4 detects the DRM technique (i.e., the encryption scheme) applied to the data to be supplied.

It can enhance the security when the system 1 and host device 2 form a secure session and transfer encrypted information unique to the memory system 1 after authentication.

Further, at step S1, the host device 2 produces a content key A for DRM-A, and supplies it to the memory system 1. The control unit 21 supplies the flash controller 50 with an instruction to write the content key A to the secret data area 3b of the flash memory 3. Upon receiving the instruction from the flash controller 50, the flash memory 3 writes the content key A to the secret data area 3b.

It can enhance the security when the system 1 and host device 2 form a secure session and transfer the encrypted content key A after authentication.

Subsequently, the host device 2 encrypts content data (write data) using the content key A, the information unique to the memory system 1 and the DRM technique (DRM-A) of the host device 2, and supplies the resultant encrypted write data to the controller 4 (step S2).

After that, the control unit 21 instructs the flash memory 3 to write the encrypted write data, regardless of the DRM technique used to encrypt the write data. Accordingly, the memory area of the flash memory 3 stores write data items encrypted by different DRM techniques.

During writing, data items encrypted by DRM techniques are written to the flash memory 3 without being physically divided. Namely, it is not indispensable to perform control for, for example, storing data encrypted by a certain DRM technique in a an area formed of pages, and data encrypted by another DRM technique in another area formed of pages. Of course, data items may be classified into such physically divided areas.

In a file containing encrypted write data items, information indicating DRM techniques used to encrypt the write data items may be denoted by extensions. Alternatively, the host device 2 may arrange the write data items under directories corresponding to DRM techniques. These methods enable the control unit 21 to detect the DRM technique applied to data read from the flash memory 3. Thus, the DRM technique applied to data read from the flash memory 3 can be recognized.

If it is determined at step S4 that transfer of the write data from the host device 2 to the memory system 1, or writing of the write data to the flash memory 3 is not finished, steps S2 and S3 are iterated.

If transfer and writing of the write data is finished, the control unit 21 informs the host device 2 of this (step S5), which is the termination of write processing.

Referring then to FIGS. 7 to 10, the operation of reading data from the memory system 1 will be described. Assume here that the host device 2 requesting to read data differs from the above-described host device that has requested to write data, and that the DRM technique employed by the latter differs from that employed by the former.

The host device 2 negotiates with the control unit 21 on DRM (step S11). The negotiation includes notification of the DRM technique of the host device 2 to the controller 4.

The host device 2 accesses the memory system 1 and designates content data (read data) to be read (step S12). Specifically, the host device 2 supplies the control unit 21 with a read command and a logical address assigned to read data. Assume that the read data is already encrypted by DRM-A.

Subsequently, the control unit 21 accesses the flash memory 3 to read the read data with the designated logical address (step S13).

After that, the control unit 21 determines the DRM technique that has been used to encrypt the read data (step S14). This determination is executed referring to, for example, the directory information or file extension of the read data.

If the DRM technique (DRM-A) of the read data is identical to that (DRM-A) of the host device 2 (see FIG. 9), the control unit 21 supplies the host device 2 with the content key A and unique information that have been used to write the read data, and the read data (step S15).

It can enhance the security when the system 1 and host device 2 form a secure session and transfer encrypted unique information and the content key A after authentication.

Thereafter, the process proceeds to step S16, where it is determined whether the output of the read data is completed. If the output of the read data is not completed, the steps S12 to S15 are iterated.

At step S14, if it is determined that the DRM technique (DRM-A) of the read data differs from that (DRM-B) of the host device 2 (see FIG. 10), the process proceeds to step S21. At steps S21 et seq., the control unit 21 performs control for converting the read data to data encrypted using the DRM technique of the host device 2.

Specifically, at step S21, the control unit 21 instructs the encryption/decryption unit 22 to decrypt the read data. The encryption/decryption unit 22 is configured to perform the same encryption and decryption as those according to the DRM technique (DRM-A) of the read data. The encryption/decryption unit 22 receives the read data output from the flash memory 3, and then decrypts it in units of preset sizes, using the RAM 30 as a working memory. The decryption is executed, using the content key A and the information unique to the memory system 1, which were used when the original data was encrypted to produce the read data. Accordingly, the read data can be successfully decrypted.

After that, in accordance with an instruction from the control unit 21, the encryption/decryption unit 23 encrypts the read data decrypted by the encryption/decryption unit 22 (step S22). The encryption/decryption unit 23 is configured to perform encryption corresponding to the DRM technique (DRM-B) of the host device 2 that is currently requesting reading.

More specifically, at step S22, the encryption/decryption unit 23 receives the read data decrypted by the encryption/decryption unit 22, and encrypts it in units of preset sizes, using a content key B and the information unique to the memory system 1, and using the RAM 30 as a working memory.

Subsequently, the control unit 21 supplies the host device 2 with the read data encrypted by the encryption/decryption unit 23 (step S23). The host device 2, in turn, decrypts the read data using the content key B and unique information.

If it is determined at step S24 that the output of the read data is not yet completed, steps S12 to S14 and S21 to S23 are iterated.

If it is determined at step S16 or S24 that the output of the read data is already completed, the read operation is finished.

In the first embodiment, read data is output from the memory system 1, encrypted according to the DRM technique of the host device that requests to read the data. Accordingly, even when the DRM technique of the host device 2 that requests reading differs from that applied to the to-be-read data stored in the memory system 1, the host device 2 can read the data.

Further, in the first embodiment, the DRM technique applied to read data is converted into another DRM technique within the memory system 1. Accordingly, plain text read data, which is inevitably produced during the conversion, is prevented from leaking to the outside of the memory system 1, unlike the case where the conversion is executed in the host device 2. Thus, plain text read data is prevented from being illegally accessed from the outside. Furthermore, plain text read data is produced in the RAM 30. Since the RAM 30 is under the control of the MPU 20 and cannot directly be accessed from the outside, the security of the read data is very high.

### Second Embodiment

In a second embodiment, encrypted write data is converted into data encrypted using a preset DRM technique.

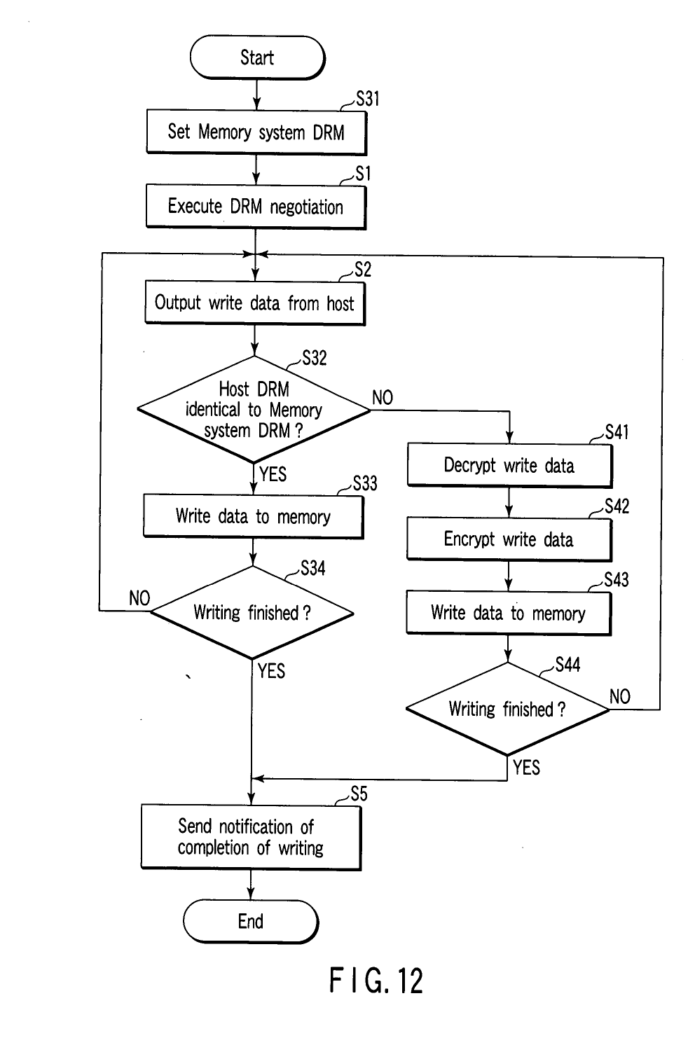

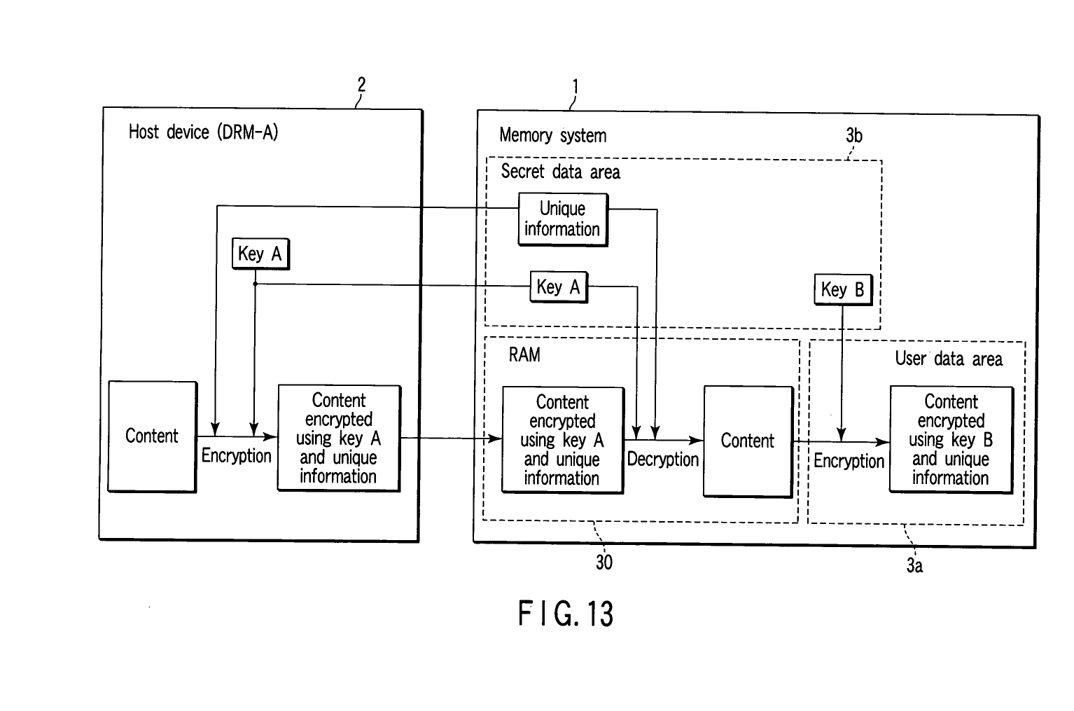

The configuration of a memory system according to the second embodiment is similar to that of the memory system according to the first embodiment shown in FIGS. 1 and 2, except for the way of control by the control unit 21. Therefore, only the operation of the memory system will now be described with reference to FIGS. 11 to 13. FIGS. 11 and 12 show a sequence and flow of the write operation of the memory system of the second embodiment, respectively. FIG. 13 shows the data sent to and received by the memory system of the second embodiment during writing, and the states of write data.

Referring to FIGS. 11 to 13, the operation of writing data to the memory system 1 will be described. Firstly, a DRM technique to be applied to data written to the flash memory 3 is selected from a plurality of DRM techniques employed by the controller 4 (step S31). This setting may be executed on the memory system 1 as a default, or be manually executed via the host device 2 whenever a user writes data to the memory system 1.

Subsequently, the host device 2 negotiates on DRM with the controller 4 (step S1). The negotiation at step S1 includes transfer of information unique to the memory system 1 and necessary for encryption by the host device 2, transfer of information on which DRM technique (DRM-A) the host device 2 uses, and transfer of the content key A for the DRM technique of the host device 2.

After that, the host device 2 encrypts write data using its DRM technique, the content key A and the information unique to the memory system 1, and supplies the encrypted write data to the controller 4 (step S2).

The controller 4 (control unit 21), in turn, determines whether the DRM technique of the host device 2 obtained at step S1 is identical to the DRM technique set therein (step S32). This determination is executed referring to, for example, the directory information or file extension of the read data, as at step S14.

If the DRM techniques are identical (see FIG. 6), the encrypted write data is written, unchanged, to the user data area 3b of the flash memory 3 (step S33), as at step S3.

If it is determined at step S34 that transfer of the write data from the host device 2 to the memory system 1, or writing of the write data to the flash memory 3 is not finished, steps S2, and S31 to S33 are iterated.

If it is determined at step S32 that the DRM technique of the host device 2 is not identical to the DRM technique set in the memory system 1 (see FIG. 13), the process proceeds to step S41. At step S41, under the control of the control unit 21, the encryption/decryption unit 22 decrypts the write data in units of preset sizes based on the content key A and information unique to the memory system 1, using the RAM 30 as a working area, and sequentially outputs the resultant write data items. The encryption/decryption unit 22 is configured to perform encryption/decryption according to the DRM technique (DRM-A) of the host device 2 that is currently requesting writing.

The encryption/decryption unit 23 follows the instruction from the control unit 21 to produce a content key B and store it in the secret data area 3b. The encryption/decryption unit 23 is configured to perform encryption/decryption according to the DRM technique which is set at step S31.

After that, the encryption/decryption unit 23 encrypts the write data, decrypted by the encryption/decryption unit 22, in units of preset sizes based on the content key B, using the RAM 40 as a working area (step S42).

Thereafter, the flash memory 3 stores, in the user data area under the control of the control unit 21, the write data encrypted by the encryption/decryption unit 23 (step S43).

If it is determined at step S44 that transfer of the write data from the host device 2 to the memory system 1, or writing of the write data to the flash memory 3 is not finished, steps S2, S32 and S41 to S43 are iterated.

If it is determined at step S34 or S44 that transfer of the write data from the host device 2 to the memory system 1, and writing of the write data to the flash memory 3 are finished, the control unit 21 informs the host device 2 of this (step S5).

The operation of reading data from the memory system 1 is identical to that of the first embodiment.

In the memory system of the second embodiment, read data is output from the memory system 1, encrypted according to the DRM technique of the host device 2 that requests to read the data, as in the first embodiment. Accordingly, the second embodiment can provide the same advantage as that of the first embodiment.

Further, in the second embodiment, encrypted write data is converted into data encrypted using a DRM technique selected by the user of the memory system 1, and is then written to the flash memory 3. Therefore, if the DRM technique applied to write data is set to correspond to that of the host device 2 which users often uses to read content data, the time for converting the DRM of read data can be eliminated.

### Third Embodiment

In a third embodiment, a single encryption scheme is employed, regardless of the DRM technique of write data as in the second embodiment.

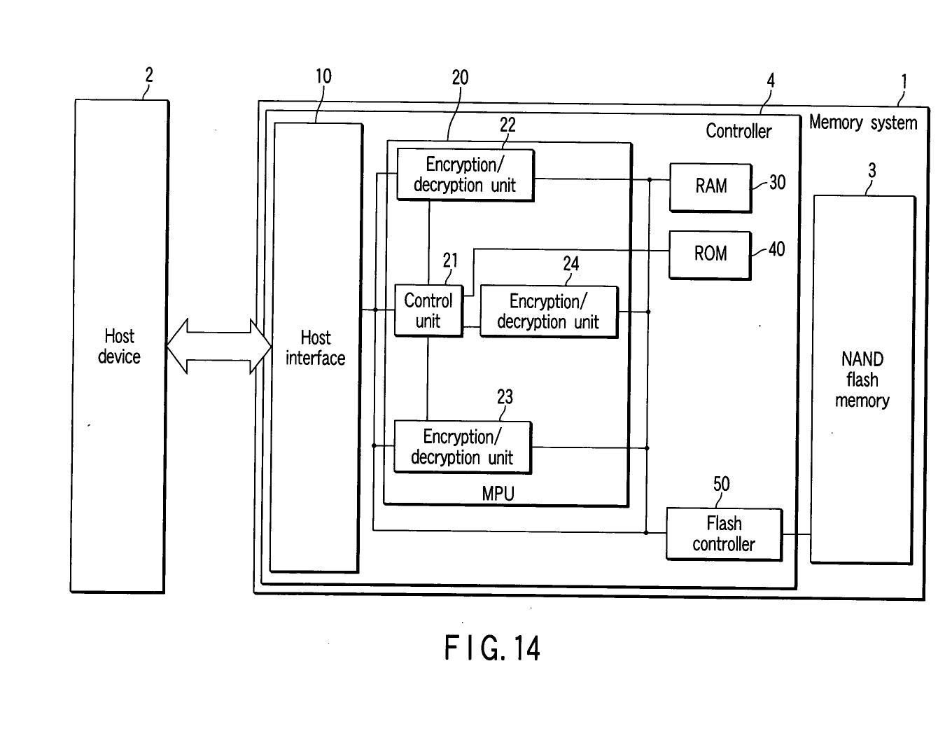

FIG. 14 is a block diagram illustrating the essential part of a memory system according to the third embodiment. As shown in FIG. 14, the MPU 20 employed in the third embodiment comprises a control unit 21 and encryption/decryption units 22 to 24.

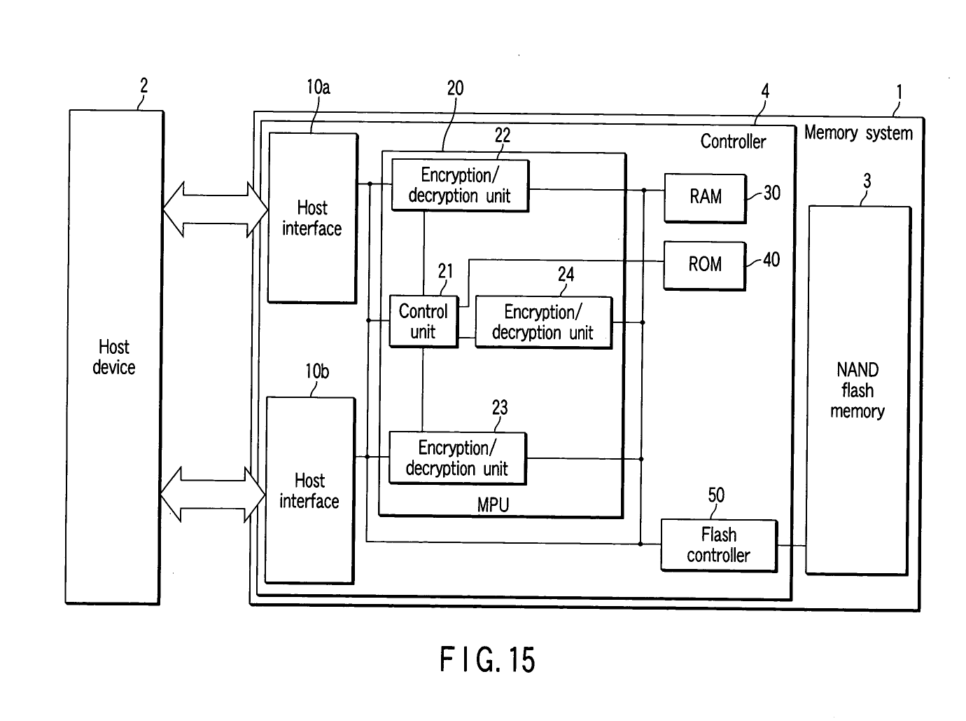

When communication is based on an interface in accordance with two or more DRM techniques that the controller 4 support, the host device and memory system are configured as shown in FIG. 15. As shown, the host interface 10 includes at least two interfaces 10a and 10b, as in the case of FIG. 3.

The encryption/decryption unit 24 shown in FIG. 14 or 15 executes encryption/decryption using a particular DRM technique (DRM-Z). This DRM technique is used for internal processing in the memory system 1. For example, this DRM technique is a known DRM technique but is not published. Accordingly, the encryption scheme (i.e., the DRM technique) cannot be detected from the outside, which exhibits high security against, for example, hacking.

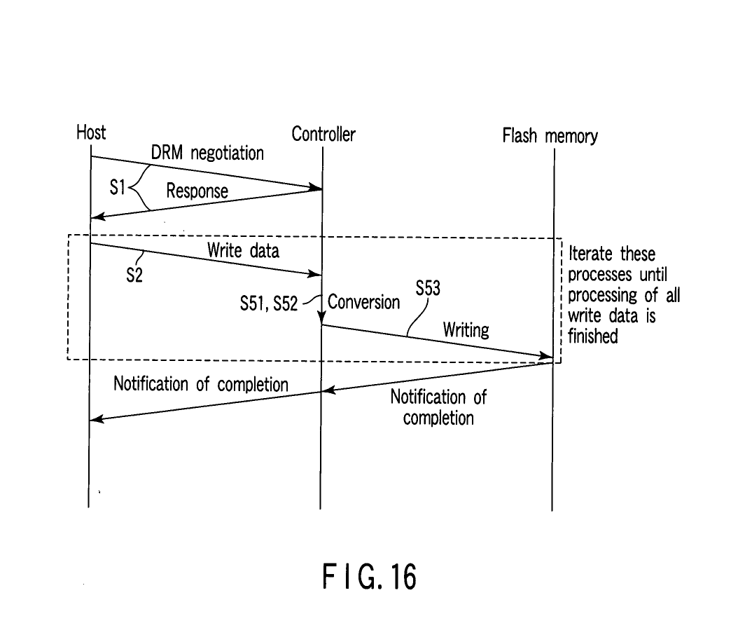

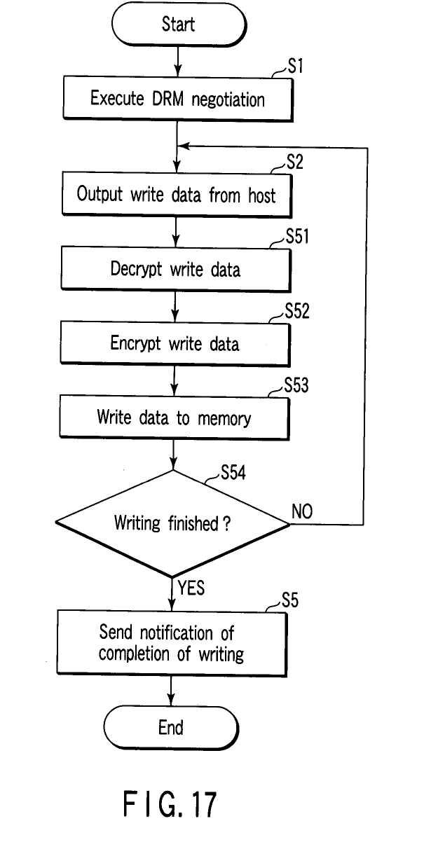

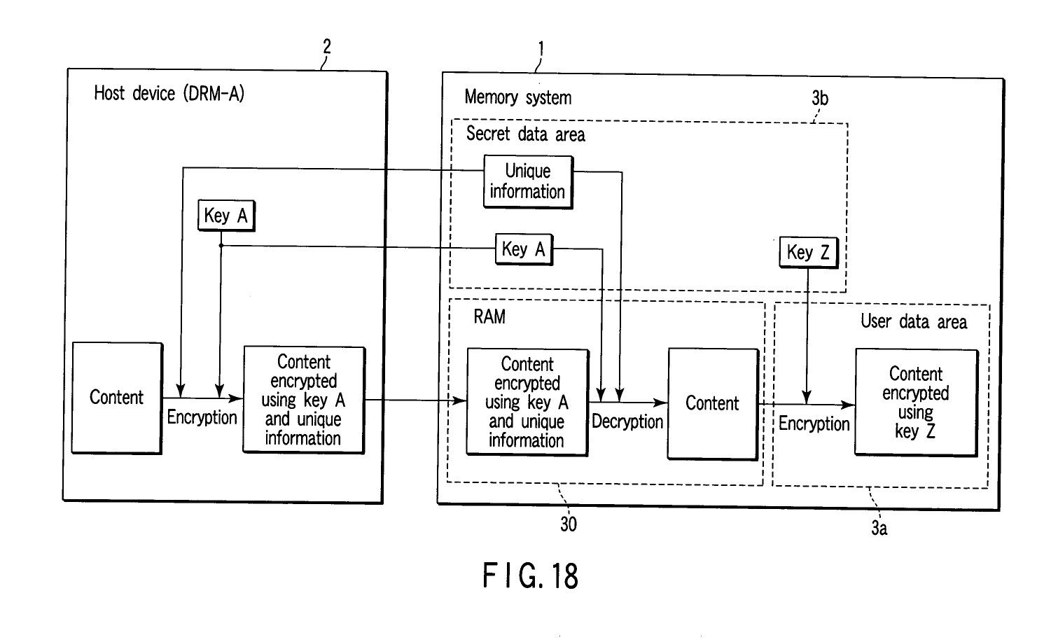

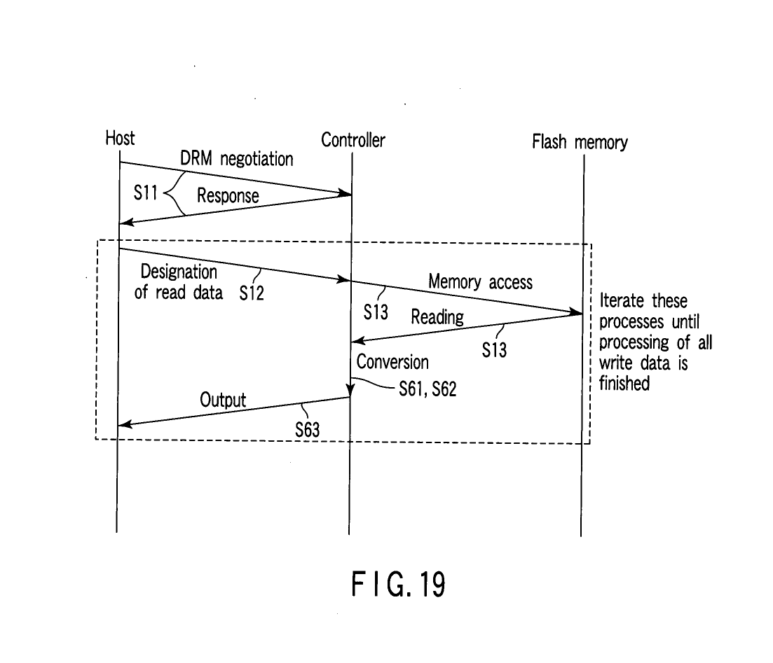

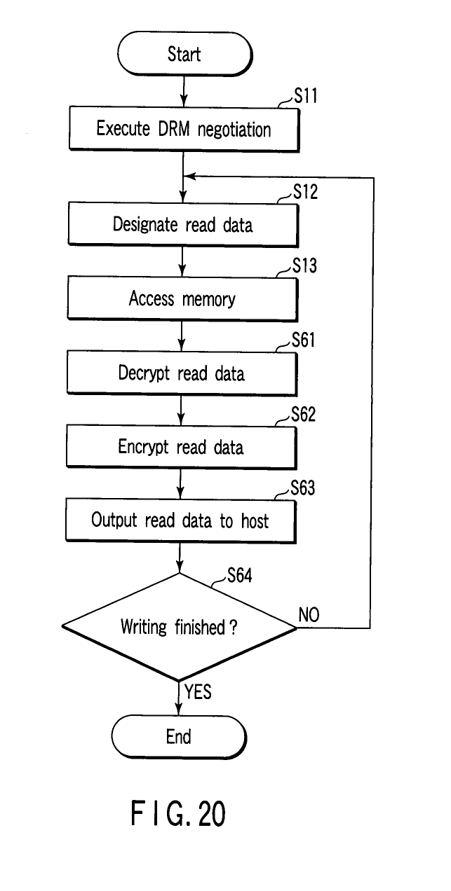

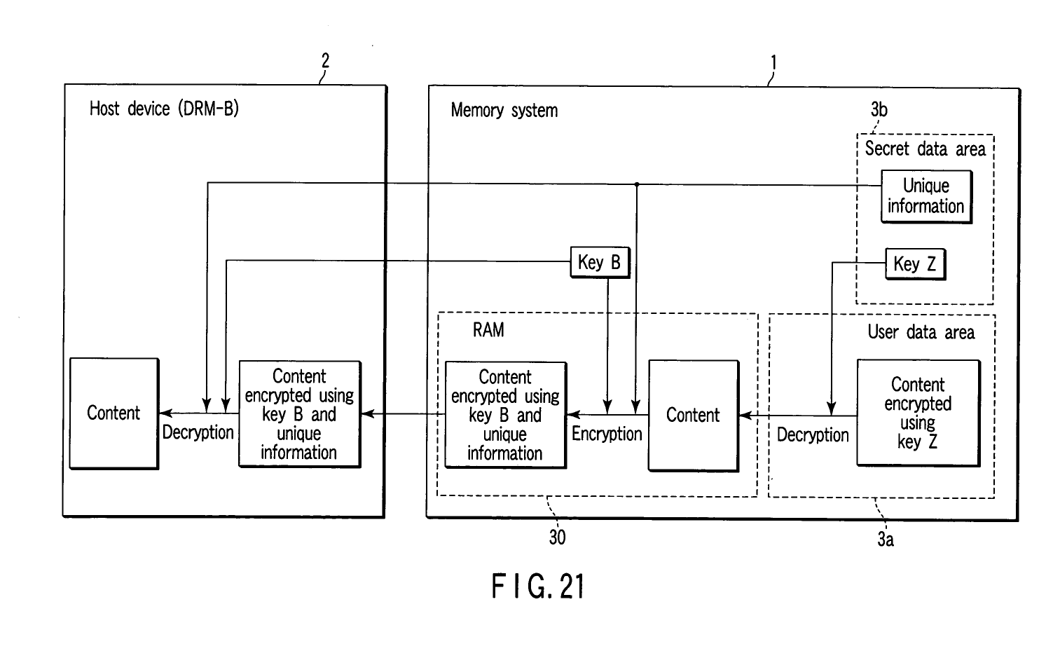

Referring then to FIGS. 16 to 23, the operations of the memory systems shown in FIGS. 14 and 15 will be described. FIGS. 16 and 17 show a sequence and flow, respectively, of the write operation of each memory system according to the third embodiment. FIG. 18 shows data used during the write operation of each memory system of the third embodiment, and the states of write data. FIGS. 19 and 20 show a sequence and flow of the read operation of each memory system of the third embodiment. FIG. 21 shows data used during the read operation of each memory system of the third embodiment, and the states of read data.

Referring first to FIGS. 16 to 18, the operation of writing data to the memory system 1 will be described.

Firstly, the host device 2 negotiates with the controller 4 on DRM (step S1). This negotiation includes transfer of information unique to the memory system 1 and necessary for encryption by the host device 2, transfer of information on which DRM technique (DRM-A) the host device 2 uses, and transfer of the content key A for the DRM technique of the host device 2.

Subsequently, the host device 2 encrypts content data (write data) using the content key A, the information unique to the memory system 1 and the DRM technique (DRM-A) of the host device 2, and supplies the resultant encrypted write data to the controller 4 (step S2).

The controller 4, in turn, decrypts the write data regardless of the DRM technique used to encrypt the write data. Namely, at step S51, under the control of the control unit 21, the encryption/decryption unit 22 decrypts the write data in units of preset sizes based on the content key A, using the RAM 30 as a working area. The encryption/decryption unit 22 is configured to perform encryption/decryption according to the DRM technique (DRM-A) of the host device 2 that is currently requesting writing.

The encryption/decryption unit 24 produces a content key Z and stores it in the secret data area 3b. The encryption/decryption unit 24 is configured to perform encryption/decryption according to a DRM technique (DRM-Z) used for the internal processing of the memory system 1.

DRM-Z may not be included in the DRM techniques supported by the memory system 1. In this case, all write data is converted into data encrypted using DRM-Z. In contrast, if DRM-Z is one of the DRM techniques supported by the memory system 1, the same processing as in the second embodiment is executed.

The encryption/decryption unit 24 encrypts the write data, decrypted by the encryption/decryption unit 22, in units of preset sizes, using the content key Z and using the RAM 30 as a working area, and sequentially outputs the resultant encrypted data items (step S52).

The write data encrypted by the encryption/decryption unit 24 is stored in the user data area 3a of the flash memory 3 under the control of the control unit 21 (step S53).

If it is determined at step S54 that transfer of the write data from the host device 2 to the memory system 1, or writing of the write data to the flash memory 3 is not finished, steps S2 and S51 to S53 are iterated.

If it is determined at step S54 that writing of the write data is finished, the control unit 21 informs the host device 2 of this (step S5).

Referring now to FIGS. 19 to 21, the operation of reading data from the memory system 1 will be described. The control unit 21 negotiates, at step S11, on DRM with the host device 2 in which the memory system 1 is inserted, thereby detecting the DRM technique of the host device 2.

The host device 2 accesses the memory system 1 and designates read data to be read (step S12). Subsequently, the control unit 21 accesses the flash memory 3 to read the read data (step S13).

Subsequently, the control unit 21 performs control for converting the read data to data encrypted using the DRM technique (DRM-B) of the host device 2.

Specifically, under the control of the control unit 21, the encryption/decryption unit 24 receives the read data output from the flash memory 3, and decrypts it in units of preset sizes, using the content key Z and using the RAM 30 as a working memory (step S61). Since the content key Z is the key that was used to encrypt the read data, the read data can be successfully decrypted using this key.

The encryption/decryption unit 23 encrypts the read data decrypted by the encryption/decryption unit 24 (step S62). The encryption/decryption unit 23 is configured to perform encryption corresponding to the DRM technique (DRM-B) of the host device 2 that is currently requesting reading.

More specifically, at step S62, the encryption/decryption unit 23 produces a content key B for DRM-B under the control of the control unit 21, and supplies it to the host device 2.

Further, the encryption/decryption unit 23 receives the decrypted read data from the encryption/decryption unit 24, and encrypts it in units of preset sizes, using the content key B and the information unique to the memory system 1, and using the RAM 30 as a working memory.

Subsequently, the control unit 21 supplies the host device 2 with the read data encrypted by the encryption/decryption unit 23 (step S63). The host device 2, in turn, decrypts the read data using the content key B and unique information.

If it is determined at step S64 that the output of the read data is not finished, steps S12, S13 and S61 to S63 are iterated.

In contrast, if the output of the read data is finished, the read operation is stopped.

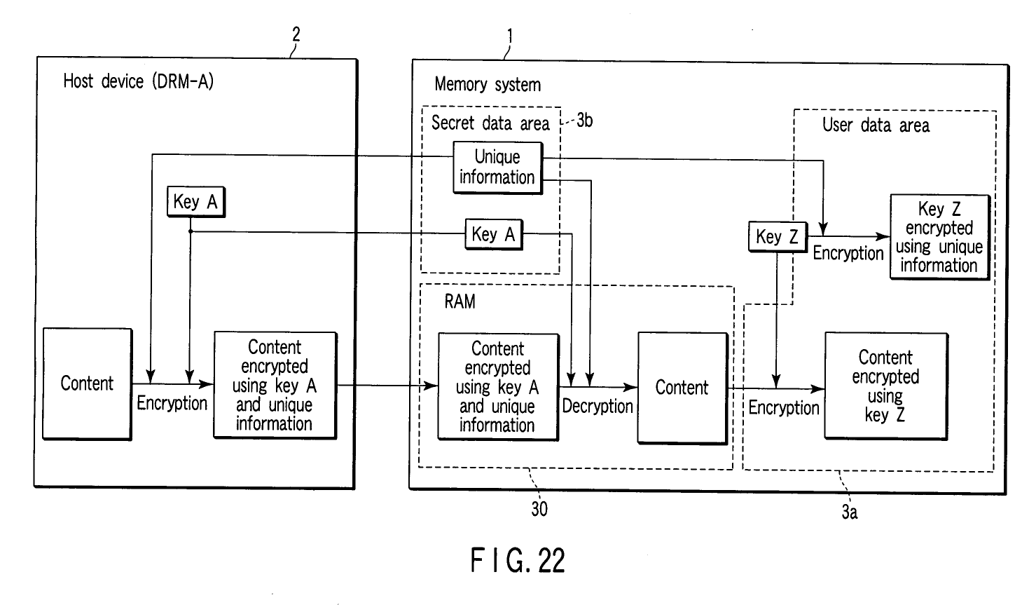

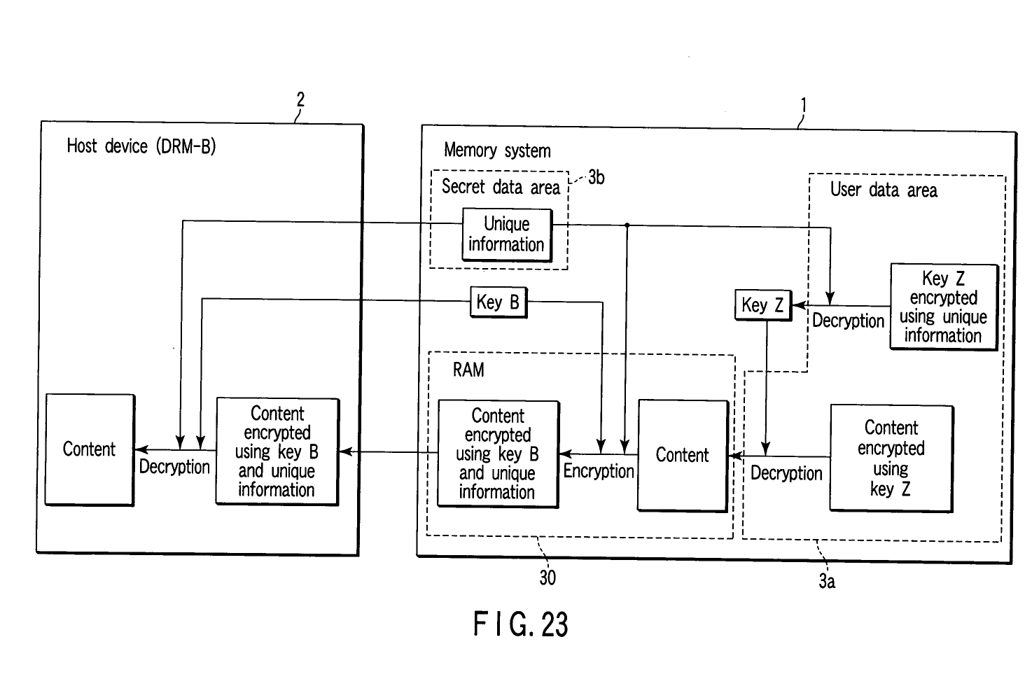

In the above structure, the content key Z is stored in the secret data area. However, it may be encrypted and stored in the user data area. FIG. 22 shows data used in the write operation of a memory system according to a modification of the third embodiment, and the states of write data. FIG. 23 shows data used in the read operation of the memory system according to the modification of the third embodiment, and the states of read data.

During a write operation, after write data is encrypted using the content key Z, the content key Z is encrypted by, for example, one of the encryption/decryption units 22 to 24, using the information unique to the memory system 1, as shown in FIG. 22. The encrypted content key Z is stored in the user data area 3a.

During a read operation, the encrypted content key Z is decrypted by the encryption/decryption unit 22, 23 or 24 that encrypted the content key Z, using the information unique to the memory system 1, as shown in FIG. 23. Using the decrypted content key Z, read data is decrypted.

In the memory system of the third embodiment, read data is output from the memory system 1, encrypted according to the DRM technique of the host device 2 that requests to read the data, as in the first embodiment. Accordingly, the third embodiment can provide the same advantage as the first embodiment.

Further, in the third embodiment, the DRM technique employed for the internal processing of the memory system 1 is maintained unpublished. This makes it very difficult to detect the technique from the outside, and hence high security against external hacking can be realized.

### Fourth Embodiment

In a fourth embodiment, all write data is stored, decrypted.

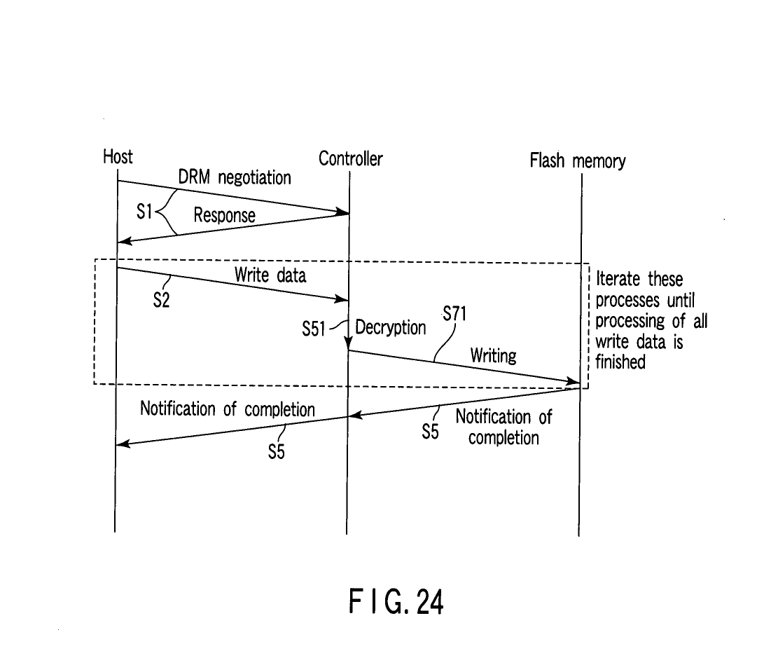

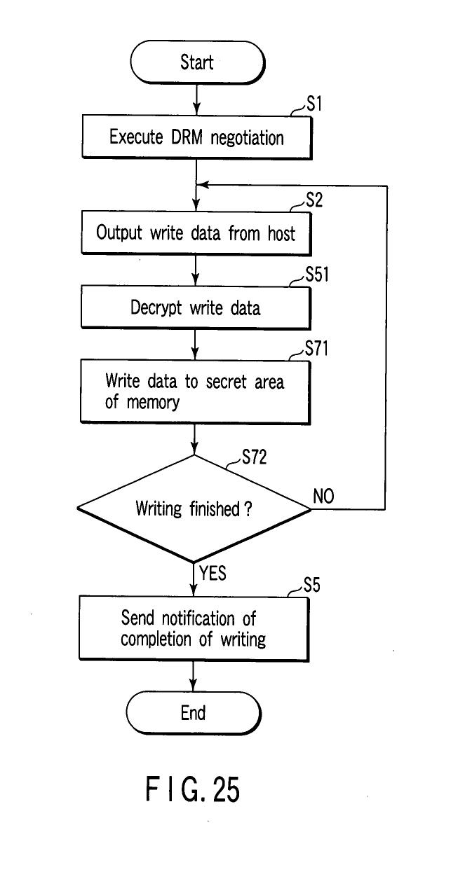

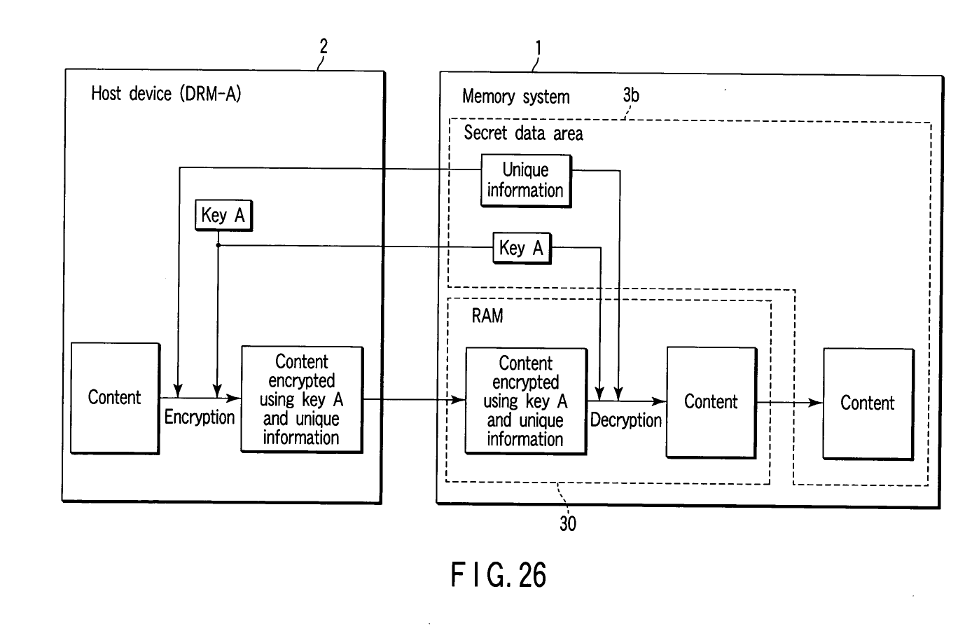

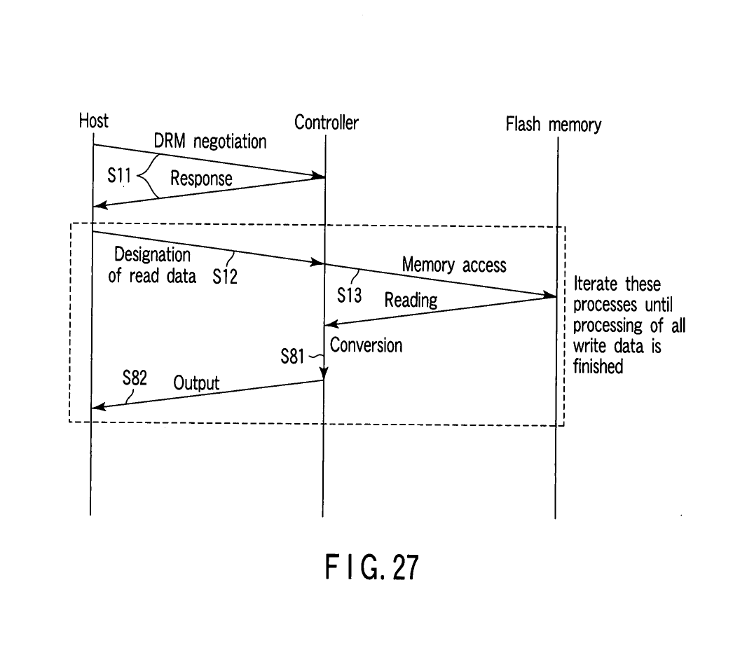

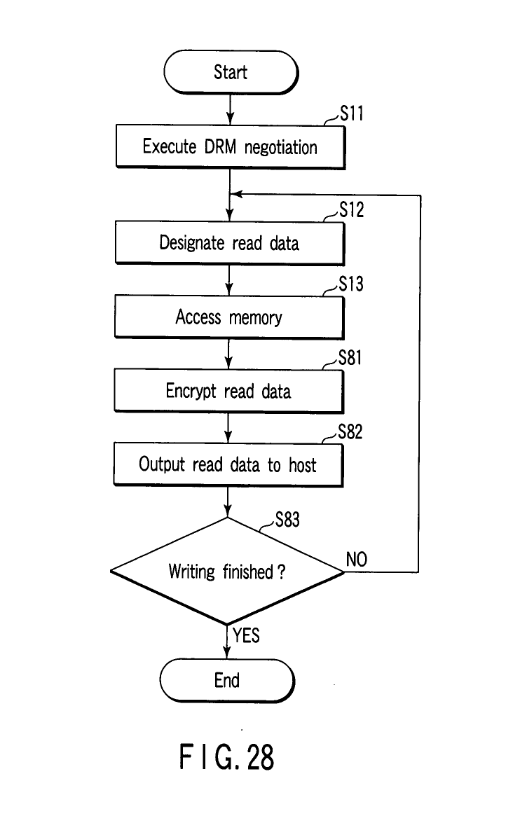

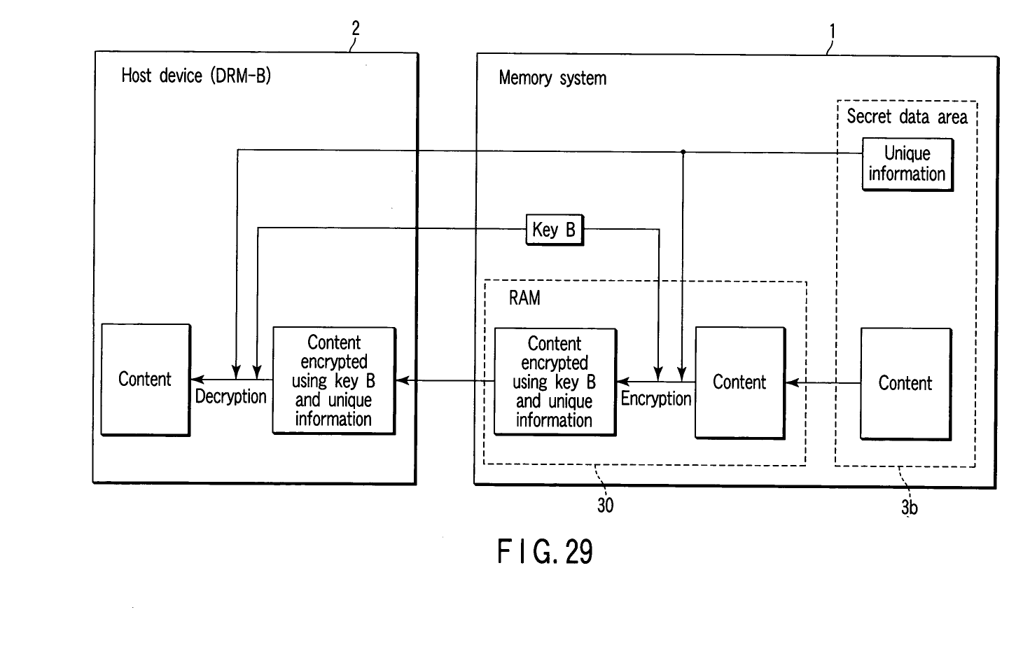

A memory system according to the fourth embodiment has the same configuration as shown in FIGS. 2 and 3 (first embodiment), or as shown in FIGS. 14 and 15 (third embodiment), and differs only in operation. Referring now to FIGS. 24 to 29, the operation of the memory system of the fourth embodiment will be described. FIGS. 24 and 25 show a sequence and flow of the write operation of the memory system of the fourth embodiment. FIG. 26 shows data used during the write operation of the memory system of the fourth embodiment, and the states of write data. FIGS. 27 and 28 show a sequence and flow of the read operation of the memory system of the fourth embodiment. FIG. 29 shows data used during the read operation of the memory system of the fourth embodiment, and the states of read data.

Referring first to FIGS. 24 to 26, the operation of writing data to the memory system 1 will be described.

The host device 2 negotiates with the controller 4 on DRM (step S1). This negotiation includes transfer of information unique to the memory system 1 and necessary for encryption by the host device 2, transfer of information on which DRM technique (DRM-A) the host device 2 uses, and transfer of the content key A for the DRM technique of the host device 2.

Subsequently, the host device 2 encrypts write data using its DRM technique, the content key A and the information unique to the memory system 1, and supplies the encrypted write data to the controller 4 (step S2).

Under the control of the control unit 21, the encryption/decryption unit 22 decrypts the write data in units of preset sizes based on the content key A and unique information, using the RAM 30 as a working area (step S51). The encryption/decryption unit 22 is configured to perform encryption/decryption according to the DRM technique (DRM-A) of the host device 2 that is currently requesting writing.

After that, under the control of the control unit 21, the write data decrypted by the encryption/decryption unit 23 is stored in the user data area 3b of the flash memory 3 (step S71).

If it is determined at step S72 that transfer of the write data from the host device 2 to the memory system 1, or writing of the write data to the flash memory 3 is not finished, steps S2, S51 and S71 are iterated.

If it is determined at step S72 that writing of the write data is finished, the control unit 21 informs the host device 2 of this (step S5).

Referring to FIGS. 27 to 29, the operation of reading data from the memory system 1 will be described. The control unit 21 negotiates, at step S11, with the host device 2 to detect the DRM technique of the host device 2.

The host device 2 accesses the memory system 1 and designates read data to be read (step S12). Subsequently, the control unit 21 accesses the flash memory 3 to read the read data (step S13).

Thereafter, under the control of the control unit 21, the encryption/decryption unit 23 produces a content key B for DRM-B, supplies the key and unique information to the host device 2, and encrypts read data, read from the flash memory 3, in units of preset sizes, using the content key B and unique information, and using the RAM 30 as a working memory (step S81). The encryption/decryption unit 23 is configured to perform encryption/decryption corresponding to the DRM technique (DRM-B) of the host device 2 that is currently requesting reading.

Subsequently, the control unit 21 supplies the host device 2 with the read data encrypted by the encryption/decryption unit 23 (step S82). The host device 2, in turn, decrypts the read data using the content key B and unique information.

If it is determined at step S83 that the output of the read data is not finished, steps S12, S13, S81 and S82 are iterated.

If it is determined at step S83 that the output of the read data is completed, the read operation is finished.

In the memory system of the fourth embodiment, read data is output from the memory system 1, encrypted according to the DRM technique of the host device 2 that requests to read the data, as in the first embodiment. Accordingly, the fourth embodiment can provide the same advantage as the first embodiment.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A memory system receiving data from a host device which requests data write, and supplying data to a host device which requests data read, comprising:
a nonvolatile semiconductor memory storing supplied data, and outputting data stored in a designated address; and
a controller supplying the memory with data in an encrypted form in accordance with a DRM technique employed by a host device which requests data write, and outputting data in an encrypted form in accordance with a DRM technique employed by a host device which requests data read.

2. The system according to claim 1, wherein:
when the controller receives a data write request of data in an encrypted form in accordance with a first DRM technique, the controller supplies the memory with data in the encrypted form in accordance with the first DRM technique;
when the controller receives a data read request from a host device which employs the first DRM technique, the controller outputs data in the encrypted form in accordance with the first DRM technique; and
when the controller receives a data read request from a host device which employs a second DRM technique, the controller outputs data in an encrypted form in accordance with the second DRM technique.

3. The system according to claim 2, wherein when the controller receives a data read request from the host device which employs the second DRM technique, the controller decrypts data in the encrypted form in accordance with the first DRM technique, encrypts decrypted data into the encrypted form in accordance with the second DRM technique, and outputs data in the encrypted form in accordance with the second DRM technique.

4. A memory system receiving data from a host device which requests data write, and supplying data to a host device which requests data read, comprising:
a nonvolatile semiconductor memory storing supplied data, and outputting data stored in a designated address; and
a controller supplying data in an encrypted form in accordance with a DRM technique by a host device which requests data write to the memory in an encrypted form in accordance with a preset DRM technique, outputting data stored in the memory in an encrypted form in accordance with a DRM technique employed by a host device which requests data read.

5. The system according to claim 4, wherein:
when the controller receives a data write request of data in an encrypted form in accordance with a first DRM technique identical to the preset DRM technique, the controller supplies the memory with data in an encrypted form in accordance with the first DRM technique; and
when the controller receives a data write request of data in an encrypted form in accordance with a second DRM technique differing from the preset DRM technique, the controller converts data into an encrypted form in accordance with the preset DRM technique, and supplies the memory with data in the encrypted form in accordance with the second DRM technique.

6. The system according to claim 5, wherein when the controller receives a data write request of data in the encrypted form in accordance with the second DRM technique, the controller decrypts data in the encrypted form in accordance with the second DRM technique, encrypts decrypted data in accordance with the preset DRM technique, and supplies the memory with data encrypted in accordance with the preset DRM technique.

7. The system according to claim 4, wherein the controller converts data in a encrypted form in accordance with the DRM technique by the host device which requests data write into data encrypted in accordance with the preset DRM technique, regardless of type of a DRM technique of the host device which requests data write.

8. The system according to claim 7, wherein the controller decrypts data supplied by the host device which requests data write, encrypts decrypted data in accordance with the preset DRM technique, and supplies the memory with data in an encrypted form in accordance with the preset DRM technique.

9. A memory system receiving data from a host device which requests data write, and supplying data to a host device which requests data read, comprising:
a nonvolatile semiconductor memory including a first memory area which is allowed to be accessed by a user of the memory system and a second memory area which is prohibited to be accessed by the user, storing supplied data, and outputting data stored in a designated address; and
a controller decrypting data in an encrypted form in accordance with a DRM technique by a host device which requests data write, requesting the memory to store decrypted data in the second memory area, outputting data in encrypted form in accordance with a DRM technique employed by a host device which requests data read.
